(19) United States
(12) Patent Application Publication
(10) Pub. No.: US 2002/0145372 A1
(43) Pub. Date: Oct. 10, 2002

(54) Spark plug without any iron tower electrode

(76) Inventor: Chin Fa Chang, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/824,811

(22) Filed: Apr. 4, 2001

(51) Int. Cl. H01T 13/20

(52) U.S. Cl. 313/141; 313/142

(57) ABSTRACT

A spark plug is disclosed. The spark plug has no iron tower electrode. A lower end of the spark plug is directly formed with a circular edge electrode. A predetermined gap is formed between the edge electrode and the central electrode. The end surface of the insulating ceramic enclosed by the electrode head is lower than the height of the end surface of the edge electrode. The electrode head of the central electrode ignites to the edge electrode at the housing. One or more conductive rings are installed on the insulating ceramic so as to be formed with a multiple ignition way. Thereby, a preferred explosion may be generated and thus no coal will be accumulated.

### FIELD OF THE INVENTION

The present invention relates to a spark plug, and especially to spark plug without any iron tower electrode.

### BACKGROUND OF THE INVENTION

Referring to FIG. 1, the prior art spark plug 10a has an ignition end to be mounted in a combustion chamber 20a. When the high voltage is applied, a spark is generated between electrodes for igniting the mixing gas 30a in the combustion chamber 20a so as to generate power to actuate the piston 40a.

With reference to FIG. 2, the prior art spark plug 10a has a central electrode 11a, a housing 12a, an iron tower electrode 13a, and an insulating ceramic 14a. The central electrode 11a is made of nickel alloy or platinum. The central electrode 11a is insulated with other portions by an insulating ceramic 14a. The upper end of the central electrode 11a may be connected to a high voltage wire of the spark plug. The housing 12a is installed with a hexagonal nut for being detached. The lower portion is installed with a thread 16a for being engaged to an engine. The iron tower electrode 13a has the function of edge electrode 13a and is connected to the lower end of the thread 16a of the housing 12a which is conductive to the engine. The insulating ceramic 14a encloses the central electrode 11a for preventing the drainage of high voltage. Sealing rings (not shown) made of such as copper and asbestos are installed in the insulating ceramic 14a so that no gas is released from the portion between the insulating ceramic 30 and the housing 20. Furthermore, as the spark plug is placed, it will prevent that as the locking force is larger, the insulating ceramic 14a will be cracked. The upper end of the insulating ceramic 14a is made with ribs 17a so as to retain a preferred insulation and has a preferred heat dissipation ability.

However, in the prior art spark plug 10a, the mixing gas is ignited by the spark between the electrode head 18aat the lower end of the central electrode 11a and the iron tower electrode 13a. Since the hinder of the iron tower electrode 13a, the spark of the spark plug can not directly contact with the mixing gas 30a (referring to FIG. 1) in the combustion chamber so that the combustion efficiency in the combustion chamber is lowered and not all power is used.

Furthermore, in the prior art spark plug 10a, no coal will be accumulated on the iron tower electrode 13a so that too much coal on the spark plug will cause the spark plug to be fired, and thus, the lifetime of the spark plug will decrease.

Moreover, U.S. Pat. No. 1,465,582 discloses a spark plug 10a without any iron tower electrode 13a (referring to FIG. 3). A cover 52a is formed at the lower end of the central electrode 50a of the spark plug 50a for covering the ignition end. Thus, the efficiency of ignition is not preferred. The spark from electric arc can not ignite in all aspects. After the car moves, the cylinder has a high temperature. The metal ring 53a is formed by a hard metal and will expand, fall down or melt by heating. Furthermore, a trench 54a is formed between different metal rings 53a. In ignition, spark will run across the trench 54a. This is so called “gap discharge”. Therefore, a larger voltage is necessary so that the function is reduced greatly.

Moreover, U.S. Pat. No. 1,461,405 discloses a spark plug 60a without any iron tower electrode 13a (referring to FIG. 4). The lower end of the central electrode 61a of the spark plug 60a is formed with a cover 62a for covering the ignition end. Thus, the efficiency of ignition is not preferred. The spark from electric arc can not ignite in all aspects. After the car moves, the cylinder has a high temperature. The metal ring 63a is formed by a hard metal and will expand, fall down or melt by heating.

Therefore, it is appreciated that in the abovesaid prior art spark plug, there are many defects necessary to be improved.

### SUMMARY OF THE INVENTION

Accordingly, the primary object of the present invention is to provide a spark plug. In the present invention, a gap formed between the central electrode and the housing is used to replace the spark plug gap between the prior art central electrode and the iron tower electrode. Since no iron tower is formed, the spark is strong. Spark from electric arc will ignite the mixing gas in all aspects. The explosion is complete and the combustion of the mixing gas is also complete.

Another object of the present invention is to provide a spark plug. Since no iron tower is used, no coal will be accumulated so that the spark plug has a longer lifetime.

A further object of the present invention is to provide a spark plug comprises a central electrode, a housing, an insulating ceramic, an edge electrode and at least one conductive rings. The housing is installed external the central electrode. The insulating ceramic is installed external the central electrode, and the insulating ceramic is installed between the central electrode and the housing. The edge electrode is forming at a lower end of the housing and having a circular shape; The conductive rings are installed at an outer surface of the insulating ceramic. Therefore, a spark plug without any iron tower electrode is formed.

The various objects and advantages of the present invention will be more readily understood from the following detailed description when read in conjunction with the appended drawing.

### BRIEF DESCRIPTION OF THE DRAWINGS

FIG. 1 is a plane view showing that a prior art spark plug is placed in a cylinder.

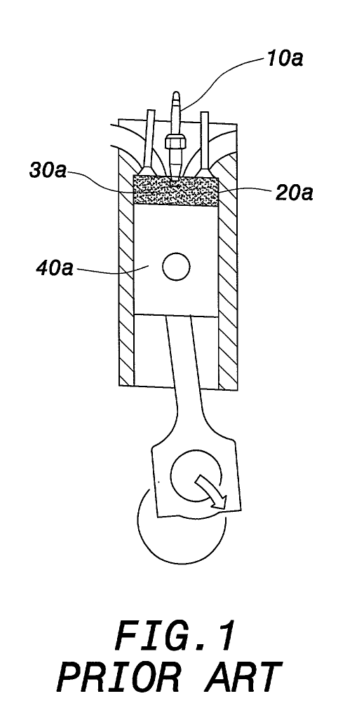

FIG. 2 is a cross sectional view of the spark plug in the prior art.

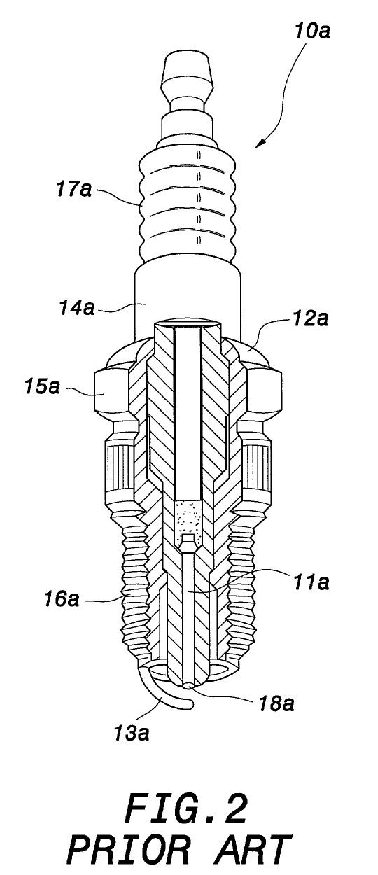

FIG. 3 is a plane view about the spark plug disclosed in U.S. Pat. No. 1,465,582.

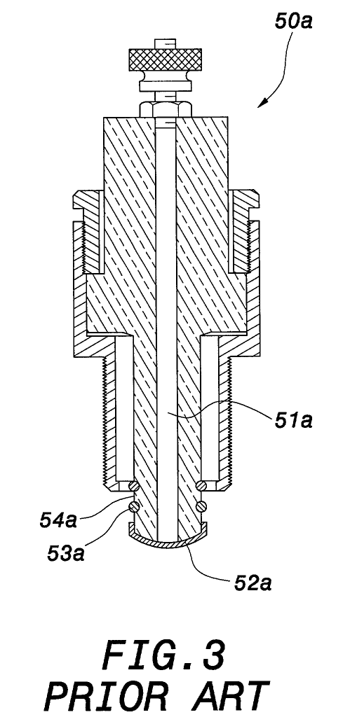

FIG. 4 is a plane view about the spark plug disclosed in U.S. Pat. No. 1,461,405.

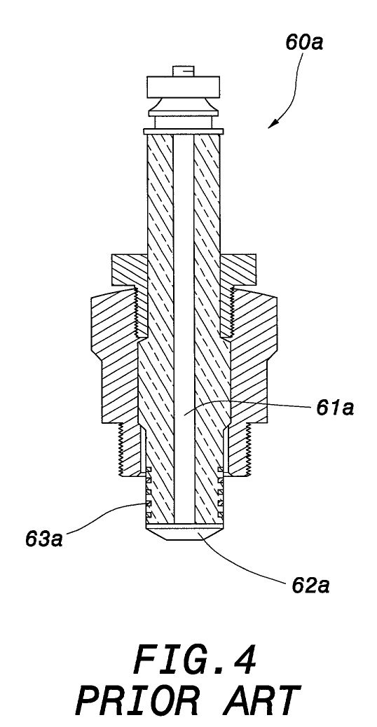

FIG. 5 is a plane cross sectional view of the first embodiment in the present invention.

FIG. 6 is a plane cross sectional view of the first embodiment in the present invention.

FIG. 7 is a plane cross sectional view of the second embodiment in the present invention.

FIG. 8 is a plane perspective view of the second embodiment in the present invention.

FIG. 9 is a plane cross sectional view of the third embodiment in the present invention.

FIG. 10 is a plane perspective view of the third embodiment in the present invention.

FIG. 11 is a plane perspective view of the fourth embodiment in the present invention.

FIG. 12 is a plane cross sectional view of the fifth embodiment in the present invention.

FIG. 13 is a plane cross sectional view of the sixth embodiment of the present invention.

FIG. 14 is a schematic view showing that the spark plug of the present invention is placed in the cylinder, wherein the arc spark causes the mixing gas to explode.

### DETAILED DESCRIPTION OF THE PREFERRED EMBODIMENTS

To further understand the present invention, a detail description of the present invention will be described in the following with the appended drawings. Those skilled in the art may completely understand the objects, characteristics and features of the present invention from these descriptions. However, those descriptions and the appended drawings are only used to describe the present invention instead of being used to confine the spirit and scope of the present invention defined in the appended claims.

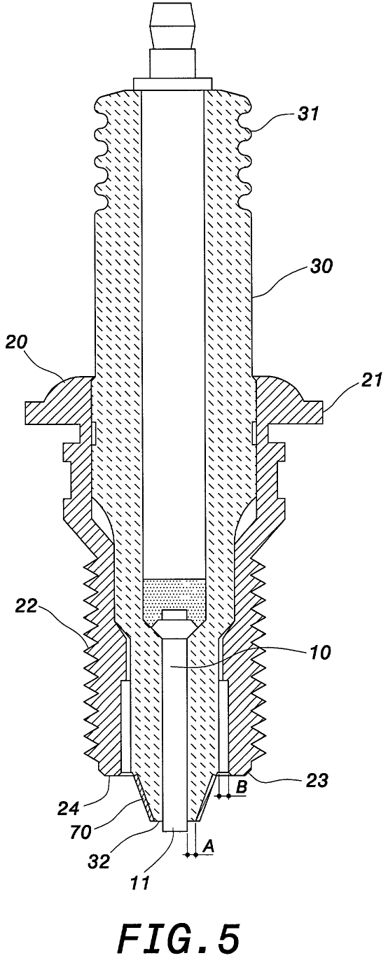

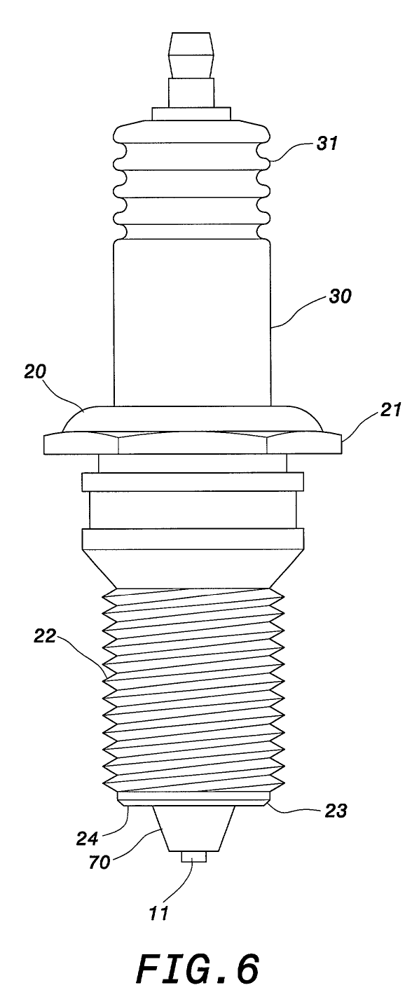

Referring to FIGS. 5 and 6, the first embodiment of the spark plug according to the present invention is illustrated. The spark plug of the present invention includes a central electrode 10, a housing 20, and a insulating ceramic 30. The central electrode 10 is made of nickel alloy or platinum which may suffer from high temperature and high voltage. An upper end of the central electrode 10 may be connected to a high voltage wire of the spark plug.

The housing 20 is made of a metal material. The upper portion thereof is installed with a hexagonal nut for being mounted and detached easily. The housing 20 is installed out of the central electrode 10. A gap is formed between the housing 20 and the central electrode 10.

The insulating ceramic 30 is installed at the exterior of the central electrode 10 for enclosing the central electrode 10 to prevent the high voltage from draining. The insulating ceramic 30 is installed between the central electrode 10 and the housing 20. The insulating ceramic 30 is insulted from other portion through the insulating ceramic 30. Sealing rings (not shown) made of such as copper and asbestos are installed in the insulating ceramic 30 so that no gas is released from the portion between the insulating ceramic 30 and the housing 20. Furthermore, as the spark plug is placed, it will prevent that as the locking force is larger, the insulating ceramic 30 will be cracked. The upper end of the insulating ceramic 30 is made with ribs 31 so as to retain a preferred insulation and has a preferred heat dissipation ability.

In the present invention, no iron tower electrode is installed to the lower end of the thread 22 of the housing 20. An annular edge electrode 23 is formed directly at a lower end of the thread 22 of the housing 20. The edge electrode 23 is used to replace the iron tower electrode of the prior art. A predetermined gap is formed between the outer diameter of the electrode head 11 at the lower end of the central electrode 10 and the inner diameter of the edge electrode 23. The end surface 32 enclosing periphery of the edge electrode 23 is lower than the end surface 24 of the edge electrode 23. Two end surfaces 32 and 24 are spaced with a predetermined gap for avoiding the conduction between the inner diameters of the edge electrode 23 and the edge electrode 23.

Of course, in order to avoid that too much length of the central electrode 10 is inserted into the combustion chamber so that the piston is possible to collide the spark plug so as to be destroyed. Therefore, the extension of the central electrode 10 is confined. In general, the number of extra added conductive rings are one to three.

In the present invention, the ignition is from the electrode head 11 of the central electrode 10 toward the edge electrode 23 of the housing 20 so that mixing gas is ignited and thus power is generated. Since no obstacle of iron tower, the spark is very strong. Especially, as the vehicle moves with a high speed, the power can be present completely. Therefore, the mixing gas can explode completely. Therefore, the present invention saves more oil than the prior spark plugs (about 10% oil is saved). Meanwhile, since no iron tower is used, no coal will be accumulated so that the spark plug has a longer lifetime.

With reference to FIGS. 5 and 6, a first embodiment of the spark plug according to the present invention is illustrated. Double ignition way is used in this embodiment. The electrode head 11 of the central electrode 10 and an end surface of the insulating ceramic 30 are extended downwards and the outer diameter of the insulating ceramic 30 is installed with a conductive ring 70 which is tilt toward the taper body. That is, the smaller the distance toward the electrode head 11, the smaller the inner diameter, and vice versa. Then sparks are generated in gaps A and B for providing a spark plug with double ignitions.

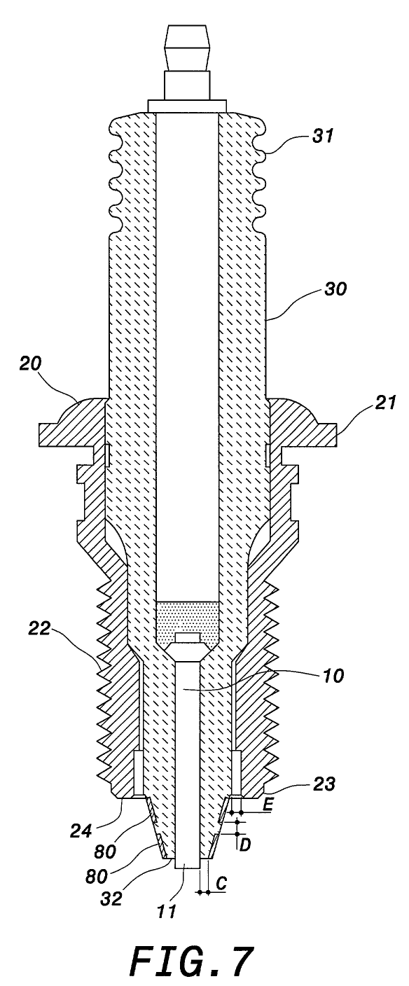

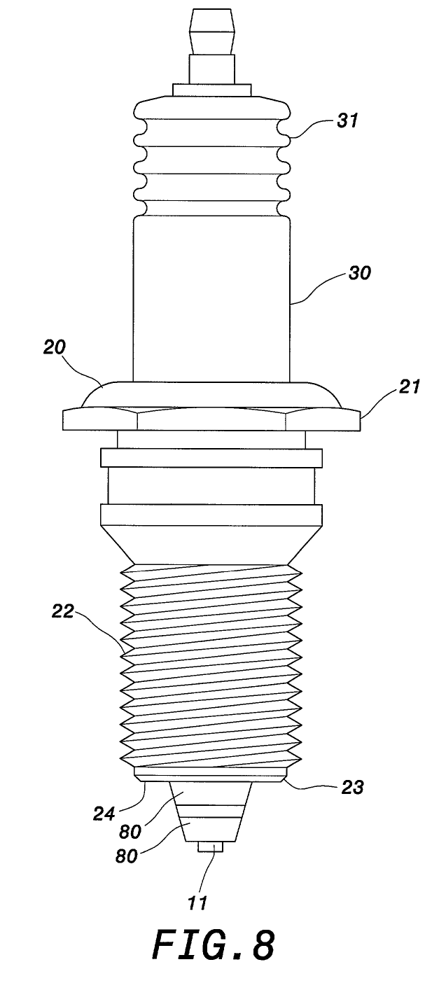

Referring to FIGS. 7 and 8, the second embodiment of the spark plug according to the present invention is illustrated. Triple ignition way is used in this embodiment. The electrode head II of the central electrode 10 and end surface 32 of the insulating ceramic 30 are extended downwards and the outer diameter of the insulating ceramic 30 is installed with two conductive rings 80 which is tilt toward the taper body. Then sparks are generated in gaps C, D and E sequentially for providing a spark plug with triple ignitions.

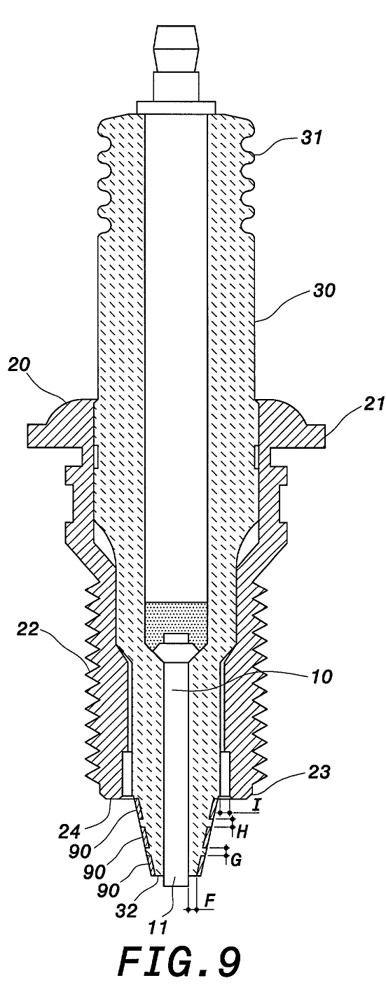

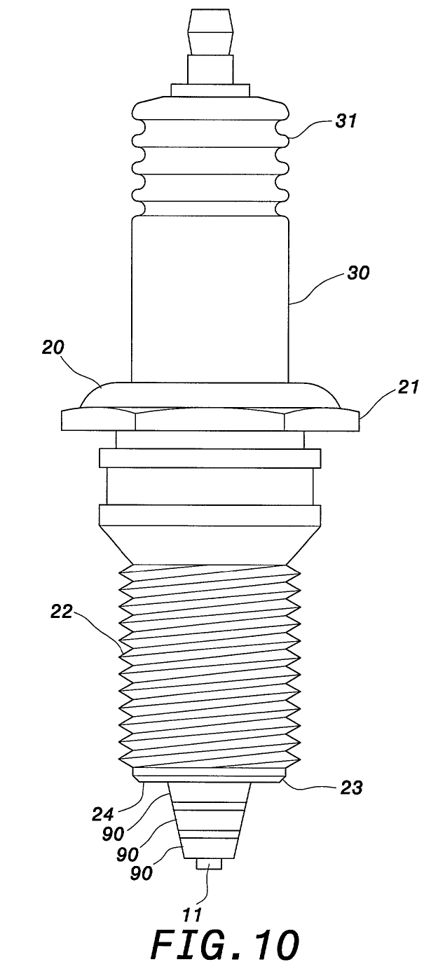

Referring to FIGS. 9 and 10, the third embodiment of the spark plug according to the present invention is illustrated. A four ignition way is used in this embodiment. The electrode head 11 of the central electrode 10 and end surface 32 of the insulating ceramic 30 are extended downwards and the outer diameter of the insulating ceramic 30 is installed with three conductive rings 90 which is tilt toward the taper body. Then sparks are generated in gaps F, G, H and I sequentially for providing a spark plug with triple ignitions.

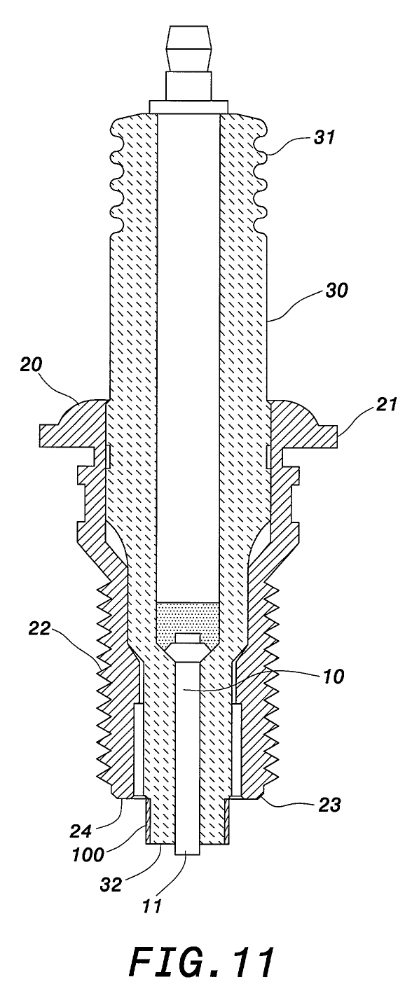

With reference to FIG. 11, a fourth embodiment of the spark plug according to the present invention is illustrated. A double ignition way is used in this embodiment. The electrode head 11 of the central electrode 10 and an end surface of the insulating ceramic 30 are extended downwards and the outer diameter of the insulating ceramic 30 is installed with a conductive ring 100 having a ladder shape for providing a spark plug with double ignitions.

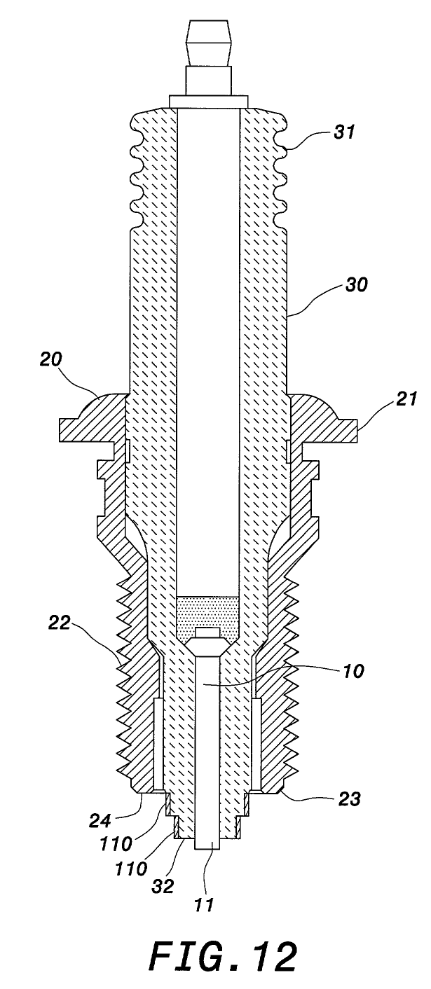

With reference to FIG. 12, a fifth embodiment of the spark plug according to the present invention is illustrated. A triple ignition way is used in this embodiment. The electrode head 11 of the central electrode 10 and an end surface of the insulating ceramic 30 are extended downwards and the outer diameter of the insulating ceramic 30 is installed with two conductive rings 110 each having a ladder shape, i.e., the smaller the distance to the electrode head 11, the smaller the inner diameter, and vice versa so as to provide a spark plug with double ignitions.

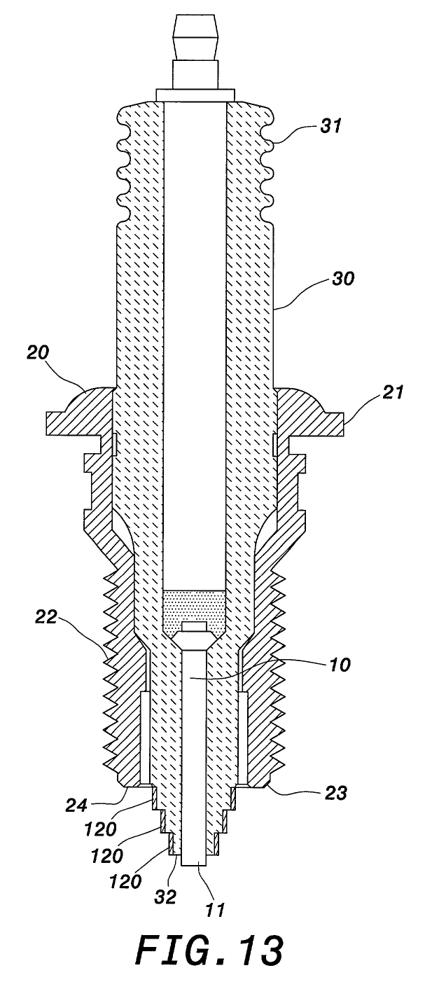

With reference to FIG. 13, a sixth embodiment of the spark plug according to the present invention is illustrated. A four-ignition way is used in this embodiment. The electrode head II of the central electrode 10 and an end surface of the insulating ceramic 30 are extended downwards and the outer diameter of the insulating ceramic 30 is installed with three conductive rings 100 having a ladder shape for providing a spark plug with four ignitions.

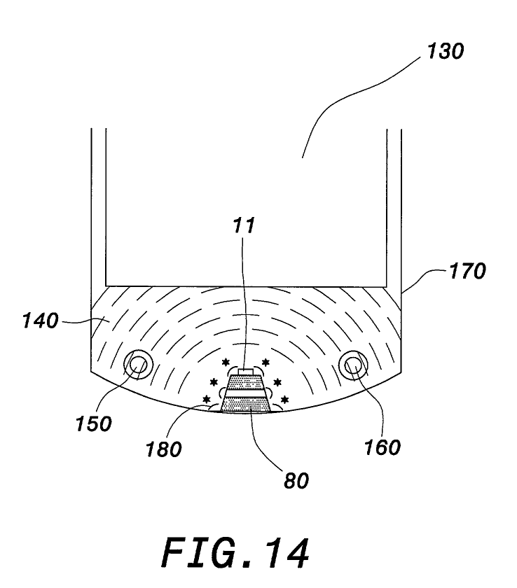

Referring to FIG. 14, in an engine, when the piston 130 compresses a mixing gas 140, the gas inlet 150 and gas outlet 160 are closed, while a closing space is formed between the wall of the engine and the piston 130. Then, the arc spark 180 illustrated in FIG. 14 will ignite the mixing gas 140 in all aspects. The explosion is complete and the combustion of the mixing gas is also complete.

Alternatively, the conductive rings of the present invention are coated by plasma coating and is formed by powders of super hard metal, such as titanium, chromium, zirconium, etc. which are high temperature endurable, does not expand, fall down, or melt. Moreover, in the present invention, no trench is formed between different conductive rings. In ignition, surface discharge or gap discharge is formed without needing a larger voltage.

In summary, the present invention improves the defects of the prior art spark plug, such as the iron tower electrode will hinder the spark plug from generating sparkle so that the sparkle can not directly contact with the mixing gas in the combustion chamber so that the combustion efficiency within the combustion chamber is not good, the power can be not present completely, coals are often accumulated on the iron tower electrode so that the spark plug will not generate spark, and thus the lifetime of the spark plug is reduced.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A spark plug comprising:
a central electrode; an electrode head being formed a lower end thereof;
a housing installed external the central electrode;
an insulating ceramic installed external the central electrode and the electrode head; the insulating ceramic being installed between the central electrode and the housing;
an edge electrode forming at a lower end of the housing and having a circular shape; and
at least one conductive rings installed at an outer surface of the insulating ceramic.

2. The spark plug as claimed in claim 1, wherein a gap is formed between an outer diameter of the electrode head at the lower end of the central electrode and an inner diameter of the edge electrode, and the end surface of the insulating ceramic enclosed by outer portion of the electrode head is lower than the height of the end surface of the edge electrode.

3. The spark plug as claimed in claim 1, wherein an upper portion of the housing is installed with a hexagonal nut and the lower portion thereof is installed with a thread.

4. The spark plug as claimed in claim 1, wherein an upper side of the insulating ceramic is installed with ribs.

5. The spark plug as claimed in claim 1, wherein the conductive ring is a tilt taper body, is coated by plasma coating, and is formed by super-hard metal powder.

6. The spark plug as claimed in claim 1, wherein the conductive ring has a ladder shape, is coated by plasma coating, and is formed by super-hard metal powder.
